(19) United States
(12) Patent Application Publication
(10) Pub. No.: US 2013/0204473 A1
(43) Pub. Date: Aug. 8, 2013

(54) METHOD FOR CHARGING A BATTERY OF A MOTOR VEHICLE, AND MOTOR VEHICLE

(71) Applicants: Florian Then, Ingolstadt (DE); Heiko Staats, Ingolstadt (DE)

(72) Inventors: Florian Then, Ingolstadt (DE); Heiko Staats, Ingolstadt (DE)

(73) Assignee: Audi AG, Ingolstadt (DE)

(21) Appl. No.: 13/582,222

(22) PCT Filed: Feb. 3, 2011
(86) PCT No.: PCT/EP2011/000496

§ 371 Date: Oct. 19, 2012

(30) Foreign Application Priority Data
Mar. 1, 2010 (EP) 10 2010 009 715.2

(51) Int. Cl. B60L 11/18

(52) U.S. Cl. CPC B60L 11/1838; B60L 11/1816
USPC 701/22

(57) ABSTRACT

The vehicle operator should be able to conveniently terminate the process of charging the battery (14) of a motor vehicle (100) with an electric drive (10). For this purpose, during charging the motor vehicle continuously or repeatedly detects whether a predetermined object is located in the vicinity of the motor vehicle, and if this is the case, the charging process is terminated and a provided locking mechanism is released. In particular a “keyless entry” function, which exists anyhow in the motor vehicle, can be used; the predetermined object is then an element having a transponder which is recognized by the motor vehicle as soon as the vehicle operator carrying this element approaches the motor vehicle.

The invention relates to a method for charging a battery of a motor vehicle, especially those motor vehicles having an electric drive for which the battery supplies the electric energy. The electric drive may be provided exclusively or be part of a hybrid drive with combustion engine. The invention also relates to a motor vehicle according to the preamble of patent claim 4.

In order to charge the battery of such a motor vehicle, the latter is driven to a charging station. The motor vehicle has a connection, e.g. a contact socket, which is coupled with a respective connection of the charging station, e.g. a plug. As known for example from DE 694 14 772 T2, provision is made for a locking mechanism which is rendered effective during charging and prevents a separation of both connections from one another, e.g. by pulling the plug from the socket.

Transponder keys are increasingly being used to replace conventional keys and remote keys for opening the doors of a motor vehicle. A vehicle operator carries a transponder which is held by a suitable element. The motor vehicle continually or repeatedly emits electromagnetic radiation. The transponder receives the electromagnetic radiation and then transmits electromagnetic radiation, namely a response signal, back to the motor vehicle, and this signal is detected by the motor vehicle. The response signal normally includes in particular an identification that is used by the motor vehicle to recognize the transponder.

EP 1 995 109 A1 discloses in the context of charging batteries of motor vehicles with electric drives the use of the transponder key for the motor vehicle also for authorization with respect to a charging station.

Charging a battery or an accumulator of a motor vehicle with electric drive normally lasts extremely long compared to a conventional fueling of a motor vehicle. Not always is such a long time available. There may also be the case that the operator of a motor vehicle has planned for an extended charging, but on short notice requires use of the motor vehicle. There may thus be a situation that requires interruption of the charging operation. Heretofore, provision has been made of functional elements, e.g. a type of “stop button” in the motor vehicle or also in charging station in order to abort the charging procedure. This has proven cumbersome.

It is an object of the invention to facilitate an interruption of the charging operation by a vehicle operator.

According to one aspect of the invention, this object is solved by a method having the features set forth in patent claim 1, and according to another aspect of the invention by a motor vehicle having the features set forth in patent claim 4.

According to the invention, the motor vehicle thus detects during charging continually or repeatedly the presence of a predetermined object in vicinity of the motor vehicle and in the event of a positive result of this detection aborts charging and releases the locking mechanism between the connectors so that the two connectors can be separated from one another.

The vehicle operator just needs to carry the predetermined object, and the motor vehicle automatically terminates the charging process when the vehicle operator with the predetermined object approaches the motor vehicle. As the charging process lasts very long, the user normally will initially have moved away from the motor vehicle. Accordingly, it is viewed as a sign of desire to continue driving, when the vehicle operator approaches the motor vehicle again.

In order to enable the vehicle operator to approach the motor vehicle, without permanently terminating the charging process, e.g. when there is an intent to remove an item from the motor vehicle, it is further advantageously asecrtained whether the connectors have been separated (also e.g. a plug is pulled) during a predefined time interval after release of the locking mechanism, and in the event this is not the case, locking is rendered effective again and charging continues.

In principle, any type of recognition of an object outside the motor vehicle can be used by the motor vehicle. Preferred is however the use of a device that exists anyway in the motor vehicle in order to detect a transponder key; the predetermined object includes thus a portable element with transponder which, when located in vicinity of the motor vehicle, converts the electromagnetic radiation emitted by the motor vehicle into a response signal that is transmitted back to the motor vehicle and detected by the motor vehicle, so that charging is terminated and the locking mechanism released, as soon as this response signal is detected.

The motor vehicle according to the invention includes a battery and a connecting device provided for charging the battery and intended for coupling with a counterpiece. Provisions are made for means for locking the object to the connecting device and in addition for a device for controlling these particular means for locking. These are features of a conventional motor vehicle with electric drive. Furthermore, the motor vehicle includes a “keyless-entry” device, here in any case at least a device for detecting the presence of a predetermined object in the vicinity of the motor vehicle, like especially a predetermined transponder.

The motor vehicle according to the invention is characterized in that the device for detecting (for “keyless-entry” in particular) is coupled with the device for controlling (for locking the connecting device with the counterpiece), and further that the device for controlling is configured to effectuate a release of the means for locking, when the predetermined object is detected by the means for detecting.

The invention puts thus two functions into context with one another so that the options made available by the motor vehicle are utilized efficiently. In particular, there is no need for a separate function “terminate charging process”, e.g. there is no longer any need for a control button for such a termination of the charging process.

The invention will now be described in greater detail by way of an example of an implementation in a vehicle with electric drive. Further ideas are hereby presented which can simultaneously be realized in the same motor vehicle. The embodiment is provided with reference to the drawings, in which:

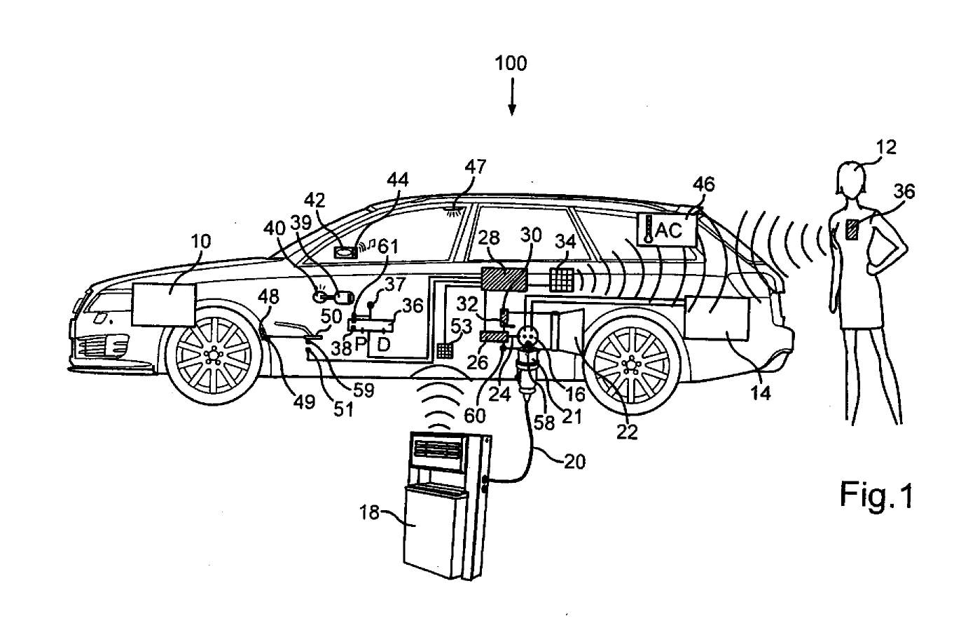

FIG. 1 shows schematically a motor vehicle with electric drive in which the present invention can be embodied;

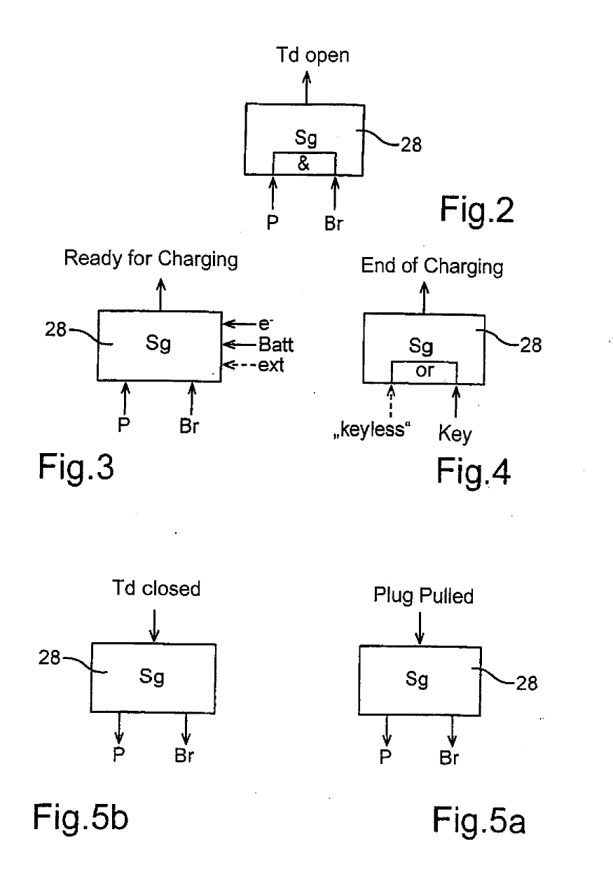

FIG. 2 is a principle diagram for explanation of an initiation process before coupling a charging station;

FIG. 3 is a principle diagram for explanation of an initiation process after docking a charging station;

FIG. 4 is a principle diagram for explanation of a process for terminating a charging process,

FIGS. 5a and 5b are principle diagrams for explanation of a process for readying the motor vehicle for operation after termination of a charging process;

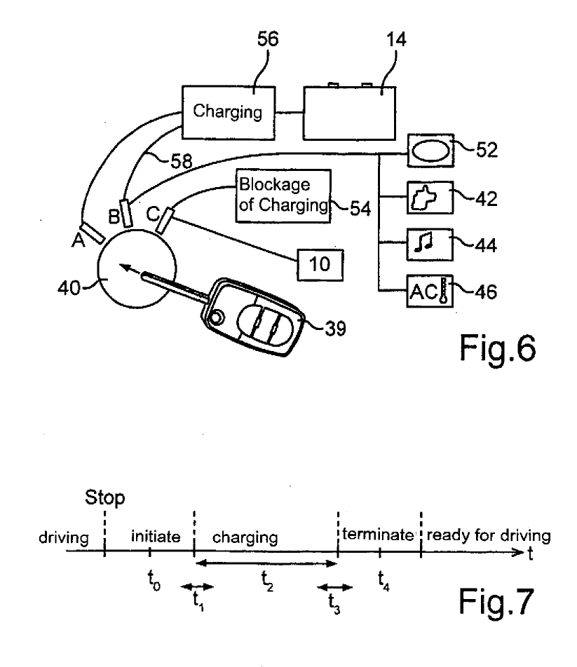

FIG. 6 shows schematically a lock for a key of a motor vehicle and units activatable by this lock,

FIG. 7 is a time characteristic in combination with a charging process with reference to a timeline, with different times and time intervals being associated to the various diagrams according to FIGS. 2 to 6.

A motor vehicle generally designated with 100 has an electric drive 10 and should be made operational for a driver 12. To supply the electric drive 10 with electrical energy, the vehicle 100 includes a battery 14. This battery is connected to a socket 16 with electrical contacts via which the battery 14 can be charged. In addition to the electrical drive, a combustion engine (not shown) can be provided, so that the electric drive becomes part of a hybrid drive.

For charging, the vehicle 100 is driven to a charging station 18, from which a line shown schematically in FIG. 1 and designated with 20 is coupled with a plug 21 to the charging socket 16 by inserting the plug 21 therein. In the normal state during travel of the motor vehicle, the socket 16 is closed by a fuel tank cap 22 which is shown in an open state in FIG. 1.

When the plug 21 is inserted in the charging socket 16, the connection can be locked by a locking element 24 shown schematically, with an actuator 26 actuating the locking element 24. The actuator 26 is operated by a control device 28. The same control device also controls an actuator 30 for a locking mechanism 32 which locks the fuel tank cap 22 during operation. The control unit 28 is also coupled to a unit 34 which automatically recognizes a transponder key 36 carried by the vehicle operator for the so-called operation of the “keyless entry”, i.e. automatic unlocking of the vehicle doors, when the vehicle operator 12 with the transponder key 36 approaches the vehicle.

The motor vehicle 100 has a circuit 36 for allowing selection of the operating states, in particular to selectively shift the motor vehicle into driving mode (“D”), or into parking mode (‘P’), in which e.g. a transmission is locked. The circuit 36 includes a selector lever 37 whose position is detected by a sensor 38.

With the assistance of a conventional key 39, the motor vehicle can be controlled via a lock 40, in particular electrical devices situated therein, and the electric drive 10 itself. Examples of electric devices may include a navigation system 42, a radio with speakers 44. Also an air conditioning system 46 can be operated via the lock 40, as is an interior lighting/lamp 47. Finally, the motor vehicle 100 further includes a parking brake 48 which can be applied via an actuating lever 50 by pulling this lever. A sensor 49 on the parking brake 48 and a sensor 51 on the actuating lever 50 ascertain the state “brake applied”. The parking brake 48 can be blocked by a bolt 59 in the pulled state, and the selector lever 37 can be blocked by a bolt 61 in the parking position.

A radio receiver 53 can receive external signals.

It is described hereinafter the manner in which the charging process of the motor vehicle 100 is executed by the charging station 18.

First, the vehicle operator 12 has to move the motor vehicle 100 to the charging station 18. In order for the charging station 18 to be coupled via the line 20 with the socket 16, the fuel tank cap 22 must be opened. In basic mode, during normal travel of the motor vehicle 100, the fuel tank cap 22 is closed by the locking element 32.

In the present case, the fuel tank cap 22 should be locked only when the selector lever 37 of the automatic transmission 36 is in the parking position “P”. This is detected by the sensor 38. At the same time, the parking brake 48 should be applied, i.e. the actuating lever 50 should be pulled. This is detected by the sensors 49 and 51. When the “P” position is reached and the brake (“BR”) is pulled, the control unit 28 causes the actuator 30 to unlock the fuel tank cap 22 (“Td open”), as shown in FIG. 2.

When the parking position of the automatic transmission 36 is engaged and at the same time the parking brake 48 is applied, the motor vehicle is effectively prevented from rolling away. A safe state is thus established, in which the charging station 18 can be coupled to the charging socket 16 via a plug. In the absence of such safety, a connection is not possible because the fuel tank cap 22 remains closed.

The process described with reference to FIG. 2 is carried out in particular during an initiation phase at a time instance to shown in FIG. 7 by way of example.

After completion of the process according to FIG. 2, the plug 21 can be inserted into the socket 16.

It should now be ensured that this plug 21 is not pulled out abruptly during charging because of the risk of damage to the battery 14 or also the charging station 18 and also the harm posed to a person pulling out the plug 21. For this reason, the plug 21 is locked by the locking unit 24 during charging.

Locking takes place prior to the onset of the actual charging under predetermined conditions, which will now be explained with reference to FIG. 3:

The selector lever 37 should still be in the parking position (“P”), and the parking brake 48 should be effective (“BR”). This is detected by the sensors 38 and 49, 51. At the same time, the battery 14 should assume a certain state (“BATT”), and also other electrical devices (“e”) should assume such a state so that the charging process does not interfere with their operations or damage them. Finally, it can be provided in addition that the radio receiver 53 receives an external signal (“ext”), especially from the charging station 18, according to which charging is enabled. Such an enable signal can be sent, for example, when the vehicle operator 12 has prepaid for a certain amount of energy (kWh). Only when all these conditions are satisfied does the control device 28 (“SG”) determine the readiness for charging. Only then is a flow of current rendered possible from the charging station 18 to the battery 14 via the socket 16.

The process described with reference to FIG. 3 is carried out in the transition from the phase of initiation to a phase of charging at a time instance t₁, see the various options for the time period of time instance t₁ in FIG. 7.

There may now be a situation in which the vehicle operator 12 wants to go to the motor vehicle 100 during charging and intends to use functions of the motor vehicle.

It is known for locks according to a type of lock 40 shown in greater detail in FIG. 6 to enable a key 39 to be moved into three different positions A, B and C. Position A corresponds to a standstill of the motor vehicle and a switch-off of all devices, i.e. an idle operating state. In position B, the motor vehicle travels, which means that the drive 10 is turned on, so that the motor vehicle is in the driving mode, when the key has previously been brought to position C. The position B can be an intermediate position. For motor vehicles with combustion engine, this intermediate position B corresponds to so-called “terminal number 15”. In the intermediate position, the navigation device 42 and the radio 44 as well as the air conditioning system 46, and optionally, a display screen 52, in particular a television set, are supplied with power, and can be made operational. Furthermore, the lamp 47 of the interior lighting can be illuminated.

It will be understood that no transfer is possible during the charging process to the state C as a result of a unit 54 which blocks charging. Conversely, when the key is in the positions A and B, a unit 56 ensures that the battery 14 is charged.

A connection 58 to the unit 56 should also be established at position B so that charging is made possible by the unit 56 even at this intermediate position B.

Thus, the navigation device 42, the radio 44, the air conditioning system 46, the lamp 47, and the display screen 52 can still be operational during charging. The vehicle operator 12, which is positioned in the vehicle 100, experiences a pleasant air conditioning of the motor vehicle and is able to use the entire vehicle infotainment system of the motor vehicle 100 which is sufficiently well lit.

The state described with reference to FIG. 6 can be set at any desired time t₂ during charging, cf. FIG. 7.

Charging an electric battery 14 lasts relatively long, especially several hours. There may be a situation in which a vehicle operator 12 desires to prematurely stop the charging process. This is facilitated in the present case through provision of a functionality made available in the motor vehicle 100: The unit 34 detects when the user 12 approaches the motor vehicle 100 with the transponder key 36 provided for the functionality of the “Keyless-Go”. This is communicated to the control device 28 via signals. The control device 28 then automatically terminates the charging process (“end of charging”) and e.g. the locking element 24 is released by the actuator 26.

Likewise, the charging process can be terminated when the vehicle operator 12 either opens the motor vehicle with the aid of a conventional key, or inserts this key 39 into the lock 40.

Of course, not every vehicle operator 12 approaching the motor vehicle 100 during the charging process intends a termination of the charging process. For this reason, provision is made for a detection as to whether the vehicle operator 12 subsequently pulls the plug out of the socket 16, or whether he closes the fuel tank cap 22, whether current still flows to the battery 14, or whether the continuation of the charging process is made impossible for whatever reason. In the absence of such a detection by the control device 28, charging is resumed after a predetermined time period and the charging process is continued.

The process described with reference to FIG. 4 occurs at a time instance t₃ during a time period, illustrated in FIG. 7, in the transition from charging to termination of the charging process.

Provision should now be made to prevent operation of the motor vehicle by a vehicle operator while the charging station 18 is still coupled to the motor vehicle 100. For this reason, a shift of the selector lever 37 away from the parking position “P” of the automatic transmission 36 is initially not possible, e.g. because the selector lever 37 is locked in the parking position “P” by the bolt 61. Likewise, the bolt 59 prevents a disengagement of the parking brake 48.

As an alternative, this lock is rendered ineffective when the plug is pulled out of the socket 16, which can be detected by a suitable sensor 58. As shown in FIG. 5a, only after the plug has been pulled is the selector lever 37 liberated or the brake “BR” disengageable.

Alternatively, provision may be made that require initial closing of the fuel tank cap 22, which can be detected by a sensor 68, and the control unit 28 permits a shift of the selector lever 37 away from the parking position “P” and a disengagement of the parking brake only when the fuel tank cap is closed (“BR”).

The process described with reference to FIGS. 5a and 5b takes place during a phase involving the termination of charging, e.g. at the time instance t₄ as shown in FIG. 7 by way of example.

Subsequently, the motor vehicle is ready for driving, and the electric drive 10 can be operated again with charged battery 14.

What is claimed is:

1.-4. (canceled)

5. A method for charging a battery of a motor vehicle, comprising:
coupling a connector of a charging station with a connector on the motor vehicle,
locking the connectors by a locking mechanism during a charging process of the battery to prevent separation of the connectors from each other;
configuring the motor vehicle to detect during the charging process continuously or repeatedly the presence of a predetermined object having a portable element with a transponder in a vicinity of the motor vehicle;
aborting the charging process in the presence of a detection of the predetermined object;
releasing the locking mechanism, when aborting the charging process, to allow separation of the two connectors; and
ascertaining during a predetermined time period after releasing the locking mechanism, whether the connectors are separated from one another, and in the absence of a separation of the connectors, reengaging the locking mechanism and continuing the charging process.

6. The method of claim 5, further comprising transforming electromagnetic radiation transmitted by the motor vehicle into a response signal to the motor vehicle when the predetermined object is in the vicinity of the motor vehicle, and configuring the motor vehicle to detect the response signal.

7. A motor vehicle, comprising:
a battery;
a connector communicating with the battery and connectable to a connector of a charging station for charging the battery;
a detector for detecting the presence of a predetermined object in the form of a portable transponder in a vicinity of the motor vehicle, said detector being configured to abort a charging process in the presence of a detection of the predetermined object;
a locking mechanism for locking the connectors; and
a control device operably connected to the detector, said control device being configured to activate the locking mechanism during the charging process for locking the connectors, to release the locking mechanism when the detector detects the presence of the predetermined object in the vicinity of the motor vehicle, and to ascertain during a predetermined time period after release of the locking mechanism, whether the connectors are separated from one another, and to effectuate a reengagement of the locking mechanism and continuance of the charging process in the absence of a separation of the connectors.
